(19) United States
(12) Patent Application Publication
(10) Pub. No.: US 2026/0069963 A1
(43) Pub. Date: Mar. 12, 2026

(54) Bowling Lane Shortening System Using a Conveyor Belt Mechanism

(71) Applicant: Dan Crivat, Lorain, OH (US)

(72) Inventor: Dan Crivat, Lorain, OH (US)

(21) Appl. No.: 19/386,347

(22) Filed: Nov. 12, 2025

(51) Int. Cl. A63D 1/04; B65G 15/30

(52) U.S. Cl. CPC A63D 1/04; B65G 15/30; B65G 2201/0214

(57) ABSTRACT

A bowling lane system is disclosed that integrates a conveyor belt into the lane surface to replicate the gameplay dynamics of a regulation-length lane within a shorter physical space. The conveyor belt spans the full width of the lane and moves in a direction opposite to the ball's travel. By selecting a belt speed based on the ball's velocity and predefined lane segment lengths, the system maintains consistent timing, spin, and impact behavior. The lane includes fixed surface portions before and after the belt to preserve player targeting and pin interaction. Optional features include sensor-based belt speed control, standard oil pattern application, and modular belt construction. The invention enables bowling centers to operate in smaller venues without compromising the player experience.

### 2. CROSS REFERENCE TO RELATED APPLICATIONS

This application is a continuation of U.S. patent application Ser. No. 19/369,424, filed Oct. 27, 2025, titled “Bowling Lane Shortening System Using a Conveyor Belt Mechanism,” which claims the benefit of U.S. Provisional Patent Application No. 63/888,296, filed Sep. 26, 2025. The entire disclosures of the foregoing applications are incorporated herein by reference.

### 3. FIELD OF THE INVENTION

The present invention relates to recreational sports equipment, and more particularly to systems and methods for modifying bowling lanes to reduce their physical length while maintaining gameplay integrity.

### 4. BACKGROUND OF THE INVENTION

Conventional bowling lanes are standardized at sixty (60) feet in length from the foul line to the headpin, limiting installation to large venues and restricting accessibility in smaller or high-rent spaces. Prior attempts at miniaturizing bowling lanes have failed to replicate the standard timing, spin dynamics, and impact behavior, resulting in diminished player experience and non-standard gameplay.

There remains a need for a system that reduces the physical footprint of a bowling lane while preserving ball motion, timing accuracy, and realistic interaction with pins.

### 5. SUMMARY OF THE INVENTION

The present invention provides a bowling lane system integrating a conveyor belt mechanism within the lane surface. The conveyor belt spans the full width of the lane and rotates in the direction opposite to the travel of the ball. This opposing motion increases the relative distance traveled by the ball, compensating for the shortened physical lane.

The conveyor belt begins at a defined distance (d1) from the foul line and ends a defined distance (d2) before the pins. Entry and exit ramps allow seamless transition between fixed and belt surfaces, maintaining ball trajectory and spin.

The belt speed (R) is dynamically or statically calibrated relative to the ball's launch speed (V), ensuring that total time-to-pins and impact speed match that of a full-length sixty-foot lane. In preferred embodiments, a six-foot conveyor belt is used, allowing the physical lane to be shortened to as little as twenty (20) feet without affecting gameplay experience.

Optional features include sensor-based control of belt speed, oil pattern application systems, and modular belt segments for maintenance or custom motion effects. The system is designed for compatibility with existing pinsetters, ball returns, and scoring systems.

### 6. BRIEF DESCRIPTION OF THE DRAWINGS

The accompanying figures illustrate preferred embodiments of the invention and are not intended to limit its scope.

### 1. Ball and Conveyor Belt Interaction

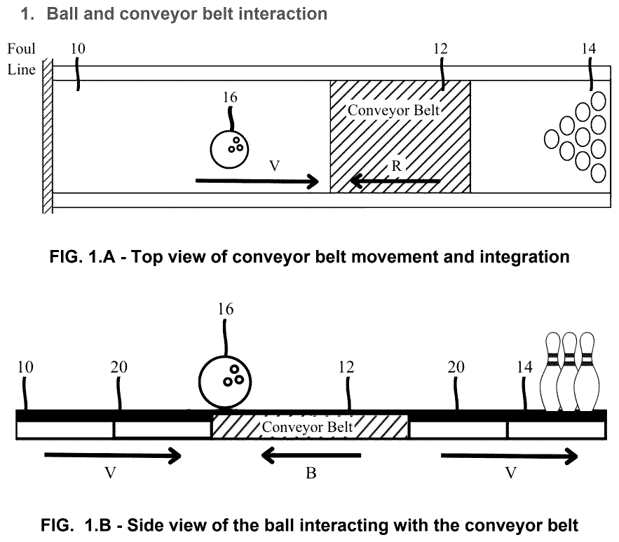

FIG. 1.A—Top view of conveyor belt movement and integration Top view of a shortened bowling lane system, showing the fixed surface portions, conveyor belt, ball position, foul line, and pin placement. The conveyor belt spans the full width of the lane and moves in a direction opposite to ball travel.

FIG. 1.B—Side view of the ball interacting with the conveyor belt Side elevation view showing a bowling ball transitioning onto the conveyor belt, which flushes with the surrounding lane surface. Direction of conveyor movement is shown.

### 2. Ball Entry/Exit Transition Ramps

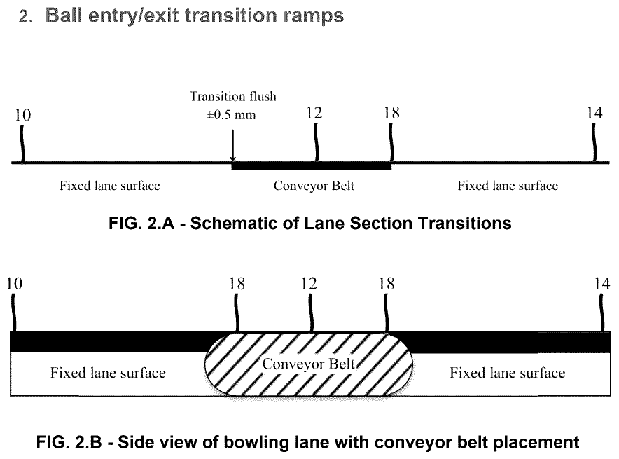

FIG. 2.A—Schematic of Lane Section Transitions Side schematic showing the three lane sections: fixed surface before the conveyor (d₁), the conveyor belt segment (L_belt), and fixed surface before the pins (d₂). All surfaces are level, with smooth transitions.

FIG. 2.B—Side view of bowling lane with conveyor belt placement

### 3. The Lengths of the 3 Sections of the Bowling Lane

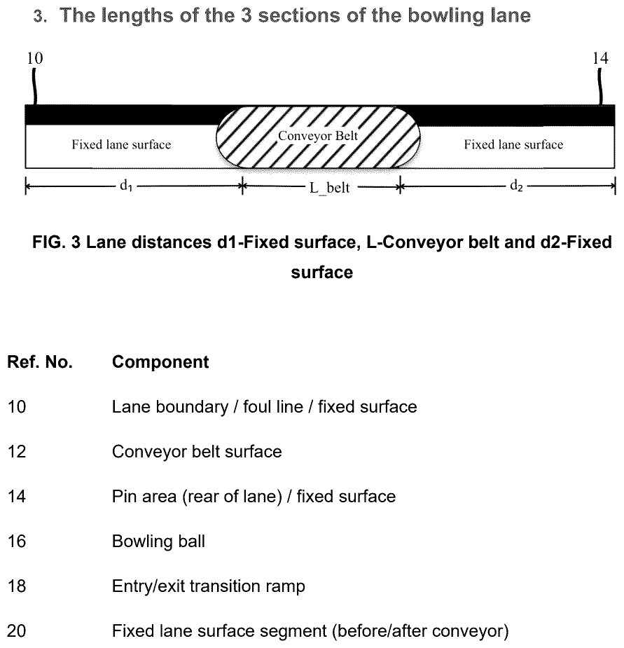

FIG. 3—Lane distances d1-Fixed surface, L-Conveyor belt and d2-Fixed surface

Schematic layout showing lane length composition: d₁ (fixed lane), L_belt (conveyor), and d₂ (fixed lane before pins). The figure emphasizes the total physical length as the sum of these components.

### 7. DETAILED DESCRIPTION OF THE INVENTION

The invention comprises a bowling lane system that incorporates a conveyor belt mechanism into the lane surface to simulate the full-length lane experience in a shorter physical space.

The conveyor belt spans the full width of the lane and moves in the opposite direction of the ball's travel. This motion effectively increases the ball's relative travel distance.

A standard bowling lane measures sixty (60) feet from the foul line to the headpin. The proposed system reduces this length to between 20 and 37 feet, while maintaining game physics, timing, and player experience.

### Lane Configuration

The lane consists of three main segments:
1. A first fixed surface portion extending from the foul line to the conveyor start, with length d₁ (typically between 8 and 16 feet).
2. A conveyor belt segment, denoted L_belt, preferably six (6) feet in length.
3. A second fixed surface portion from the conveyor end to the pins, with length d₂ (typically between 6 and 15 feet).

The total physical lane length is calculated as: L_phys=d₁+L_belt+d₂

### Ball Timing and Belt Speed

Let V be the ball's initial surface speed on the fixed lane portions (ft/s).
A standard full-length lane has baseline time-to-pins T0=60/V (constant-speed model).
With the conveyor belt integrated, total time is T=d₁/V+L_belt/(V−R)+d₂/V
Where R is the belt surface speed opposite the ball.

To reproduce the baseline timing:
R=V−L_belt/(T0−(d₁+d₂)/V)=V×(1−L_belt/(60−(d₁+d₂))). For the short-belt embodiment with L_belt=6 ft, this reduces to:
R=V×(1-6/(60−(d₁+d₂))), with 0<R<V.

This ensures both identical total travel time and identical impact speed compared to a regulation 60-ft lane.

### Example Configurations (L_belt=6 ft)

Example A—Conservative Integration (maintain feel):
d₁=16 ft, d₂=15 ft; (d₁+d₂=31 ft)
Physical lane length=37 ft (shortened by 23 ft)
R/V=1-6/(60-31)=0.7931
For V=18 mph (26.4 ft/s): R=14.28 mph (20.94 ft/s)
Effective ground speed on belt=5.46 ft/s

Example B—Aggressive Integration (max shorten):
d₁=8 ft, d₂=6 ft; (d₁+d₂=14 ft)
Physical lane length=20 ft (shortened by 40 ft)
R/V=1-6/(60-14)=0.8696
For V=18 mph: R=15.65 mph (22.96 ft/s)
Effective ground speed on belt=3.44 ft/s

Scaling Table (R for common release speeds, L_belt = 6 ft)

| Case | V = 16 mph | V = 18 mph | V = 20 mph |
|---|---|---|---|
| Conservative | 12.69 mph | 14.28 mph | 15.86 mph |
| (d1 + d2 = 31 ft) | | | |
| Aggressive | 13.91 mph | 15.65 mph | 17.39 mph |
| (d1 + d2 = 14 ft) | | | |

### Integration Features

Full-width belt matching regulation lane width
Entry/exit ramps shaped to maintain continuous roll; transitions flush within ±0.5 mm and surface roughness Ra≤50 μm
Belt surface material selected to match coefficient of friction and oil-retention characteristics of wooden/synthetic lanes
Non-interference with pinsetter, scoring system, and ball return
Optional lane oiling mechanism to apply standard oil patterns on fixed and belt surfaces
Calibration to reproduce regulation timing; optional dynamic control via sensors (ball speed, rotation, time-of-flight)

1. A bowling lane system comprising: a playing surface including a first fixed portion and a second portion formed by a conveyor belt extending across the full width of the lane; the conveyor belt being driven in a direction opposite to the direction of travel of a bowling ball delivered by a player; the conveyor belt having a surface speed configured such that the effective distance traveled by the ball and the resulting ball kinematics substantially replicate those of a regulation-length bowling lane; wherein the physical lane length is less than sixty feet.

2. The system of claim 1, wherein the conveyor belt begins at a distance d₁ from the foul line and ends a distance d₂ before the pins, and wherein the conveyor belt length L_belt is approximately six feet.

3. The system of claim 2, wherein a baseline time-to-pins for a regulation sixty-foot lane is T₀=60/V, and the belt speed R is determined to satisfy R=V−L_belt/(T₀−(d₁+d₂)/V), and wherein for L_belt=6 ft this reduces to R=V×(1−6/(60−(d₁+d₂))).

4. The system of claim 1, wherein transitions between fixed and conveyor surfaces are flush within ±0.5 mm in height and continuous within a surface roughness of Ra≤50 μm.

5. The system of claim 1, wherein the conveyor belt material is selected to match the coefficient of friction and oil-retention characteristics of a standard wooden or synthetic bowling lane.

6. The system of claim 1, wherein integration of the conveyor belt does not interfere with a pinsetter system, a scoring system, or a ball return system.

7. The system of claim 1, further comprising a lane oiling mechanism configured to apply standard oil patterns on both the fixed and conveyor surfaces.

8. The system of claim 1, wherein the conveyor belt speed is dynamically adjusted by a sensor system that measures at least one of: ball velocity, ball rotation rate, or time-of-flight.

9. The system of claim 1, wherein the conveyor belt comprises multiple independently driven segments.

10. The system of claim 1, wherein the conveyor is configured to enter a maintenance mode including reversing direction to clean or to return balls.

11. The system of claim 1, wherein effective ball motion is calibrated to conform with United States Bowling Congress play standards.

12. The system of claim 1, wherein the conveyor belt portion replaces at least thirty percent of a standard sixty-foot lane length.

13. A method of simulating a regulation-length bowling lane on a shortened lane, the method comprising: providing a conveyor belt integrated into the lane surface and spanning the full width of the lane; detecting or inferring a launch velocity of a bowled ball; driving the conveyor belt in a direction opposite to the ball's travel at a calibrated speed such that the ball's motion relative to the belt simulates motion over a full-length bowling lane; allowing the ball to transition seamlessly from a fixed surface portion to the conveyor belt and back to a fixed surface portion without disturbing spin, axis rotation, or trajectory.

14. The method of claim 13, further comprising computing the conveyor speed R based on R=V−L_belt/(60/V−(d₁+d₂)/V).

15. The method of claim 13, wherein the conveyor belt speed is controlled dynamically based on sensor measurements.

16. The method of claim 13, wherein the conveyor belt comprises multiple independently driven segments.
